(19) United States
(12) Patent Application Publication
(10) Pub. No.: US 2023/0268980 A1
(43) Pub. Date: Aug. 24, 2023

(54) METHODS, APPARATUS AND SYSTEMS USING MULTI-SET POLARIZED BEAM-TIME SHIFT KEYING (MSP-BTSK)

(71) Applicant: InterDigital Patent Holdings, Inc., Wilmington, DE (US)

(72) Inventors: Ibrahim Hemadeh, Hemel Hempstead (GB); Mohammed El-Hajjar, Southampton (GB); Alain Mourad, Staines-Upon-Thames (GB)

(21) Appl. No.: 18/014,533

(22) PCT Filed: Jul. 15, 2021
(86) PCT No.: PCT/US2021/041774

§ 371 Date: Jan. 5, 2023

Related U.S. Application Data
(60) Provisional application No. 63/052,515, filed on Jul. 16, 2020.

(51) Int. Cl. H04B 7/10; H04B 7/06

(52) U.S. Cl. CPC H04B 7/10; H04B 7/0695

(57) ABSTRACT

Method, apparatus and systems are disclosed that may be implemented. One method implemented by a transceiver, is directed to transmission via a plurality of beams. The method includes obtaining an input bit stream and bit mapping bits of the input bit stream into at least a first stream and a second stream. The method further includes, generating one or more complex symbols using the first stream, selecting a Space-Time (ST) spreading matrix from a plurality of ST spreading matrices and spreading the generated one or more complex symbols over the selected ST spreading matrix to generate one or more dispersed ST codewords. In this method the transceiver maps the one or more dispersed ST codewords to a plurality of beams and transmits the mapped one or more dispersed ST codewords over the plurality of beams.

### CROSS REFERENCE TO RELATED APPLICATIONS

This application claims the benefit of priority to U.S. Provisional Pat. Application No. 63/052,515 filed Jul. 16, 2020, which is incorporated herein by reference.

### BACKGROUND

Embodiments disclosed herein generally relate to wireless communications and, for example to methods, apparatus and systems using Multiple Input Multiple Output (MIMO) technology (e.g., including MSP-BTSK, among others).

### BRIEF DESCRIPTION OF THE DRAWINGS

A more detailed understanding may be had from the detailed description below, given by way of example in conjunction with drawings appended hereto. Figures in the description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram of a SM transmitter;

FIG. 3 is a block diagram of a STSK transmitter;

FIG. 4 is a block diagram of a MS-STSK transmitter;

FIG. 5 is a block diagram of a BIM transceiver;

FIG. 6 is a block diagram of a BTSK transmitter;

FIG. 7 is a block diagram of a representative beamforming operation for example with 2×2 ST codeword transmitted over multiple beams (e.g., two or more beams);

FIG. 8 is a block diagram of a representative MS-BTSK transmitter;

FIG. 9 is a block diagram of a representative MSP-BTSK transmitter;

FIG. 10 is a diagram of a representative MSP-BTSK transmitter including a controller;

FIG. 11 is a diagram of a representative MSP-BTSK encoding process;

FIG. 12 is a diagram illustrating a representative controller of a MSP-BTSK transmitter;

FIG. 13 is a diagram illustrating a representative MSP-BTSK receiver; and

FIG. 14 is a diagram illustrating a representative LMSP-BTSK transmitter.

FIG. 15 is a flow chart illustrating an example of a method implemented by a transceiver for transmitting via a plurality of beams.

FIG. 16 is a flow chart illustrating another example of a method implemented by a transceiver for transmitting via a plurality of beams.

FIG. 17 is a flow chart illustrating another example of a method implemented by a device for transmitting via a plurality of beams.

### DETAILED DESCRIPTION

### Example Networks for Implementation of the Embodiments

Certain embodiments may be implemented in autonomous and/or semi-autonomous vehicles, robotic vehicles, cars, IoT gear, any device that moves, or a WTRU or other communication devices, which, in turn, may be used in a communication network. The following section provides a description of some exemplary WTRUs and/or other communication devices and networks in which they may be incorporated.

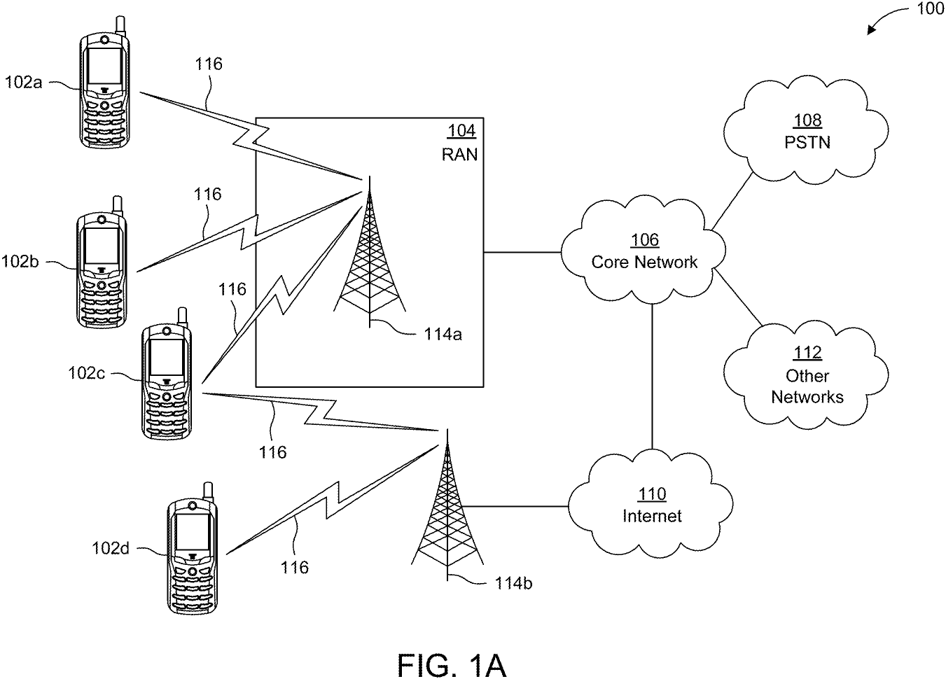

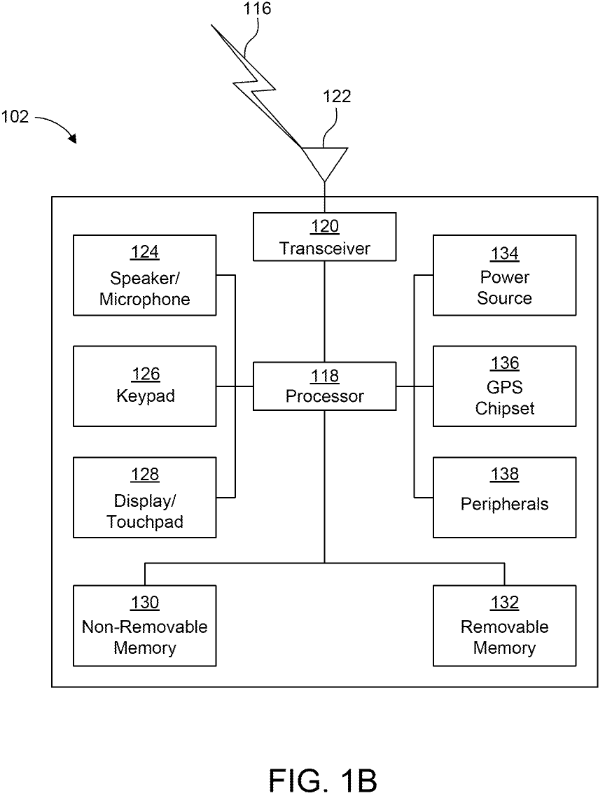

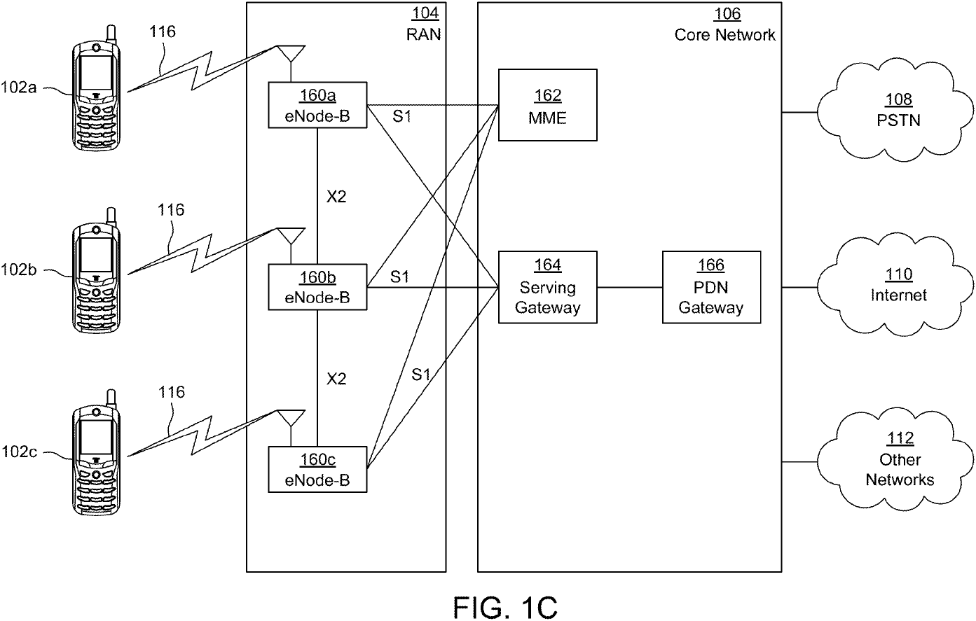

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (end), a Home Node B (HNB), a Home eNode B (HeNB), a gNB, a NR Node B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an end and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The processor 118 of the WTRU 102 may operatively communicate with various peripherals 138 including, for example, any of: the one or more accelerometers, the one or more gyroscopes, the USB port, other communication interfaces/ports, the display and/or other visual/audio indicators to implement representative embodiments disclosed herein.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode Bs 160a, 160b, 160c, though it will be appreciated that the RAN 104 may include any number of eNode Bs while remaining consistent with an embodiment. The eNode Bs 160a, 160b, 160c may each include one or more transceivers for communicating with the WTRUs 102a, 102b, 102c over the air interface 116. In one embodiment, the eNode Bs 160a, 160b, 160c may implement MIMO technology. Thus, the eNode B 160a, for example, may use multiple antennas to transmit wireless signals to, and/or receive wireless signals from, the WTRU 102a.

Each of the eNode Bs 160a, 160b, 160c may be associated with a particular cell (not shown) and may be configured to handle radio resource management decisions, handover decisions, scheduling of users in the UL and/or DL, and the like. As shown in FIG. 1C, the eNode Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode Bs 160a, 160b, 160c. For example, WTRUs 102a, 102b, 102c may implement DC principles to communicate with one or more gNBs 180a, 180b, 180c and one or more eNode Bs 160a, 160b, 160c substantially simultaneously. In the non-standalone configuration, eNode Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Protocol Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communication (URLLC) access, services relying on enhanced mobile (e.g., massive mobile) broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU 102 IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description, one or more, or all, of the functions described herein with regard to one or more of: WTRU 102a-d, Base Station 114a-b, eNode B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, methods, apparatus, systems and procedures may be implemented using Multi-Set Polarized Beam-Time Shift Keying (MSP-BTSK). The multifunctional MIMO scheme may simultaneously achieve multiplexing, diversity and beamforming gains, for example at high frequencies, where the wireless channel is typically sparse. The scheme may include any of: (1) using different beams (for example via one or more antenna arrays) to transmit separate space-time codewords; (2) assigning polarization stamps to the beams, for example to separate and/or identify beams over a polarization dimension; (3) regularly/continuously updating configurations of the beams including the polarization stamp between the transmitter and the receiver; (4) selecting a subset of the beams for transmission, for example, on condition that more beams are available than set/required by the dispersion matrices of the Space-Time (ST) codewords; (5) using the polarization stamps as a modulation technique to convey additional information; and/or (6) enabling multiple layers, for example such that multiple performance trade-offs may be achieved simultaneously from the same transmitter, among others.

Several multi-functional MIMO schemes may be implemented and may provide better/improved trade-offs between achievable multiplexing gain, diversity gain and beamforming gain for given radio channel conditions between a transmitter and a receiver as disclosed herein.

### Representative Spatial Modulation (SM) Transmitter

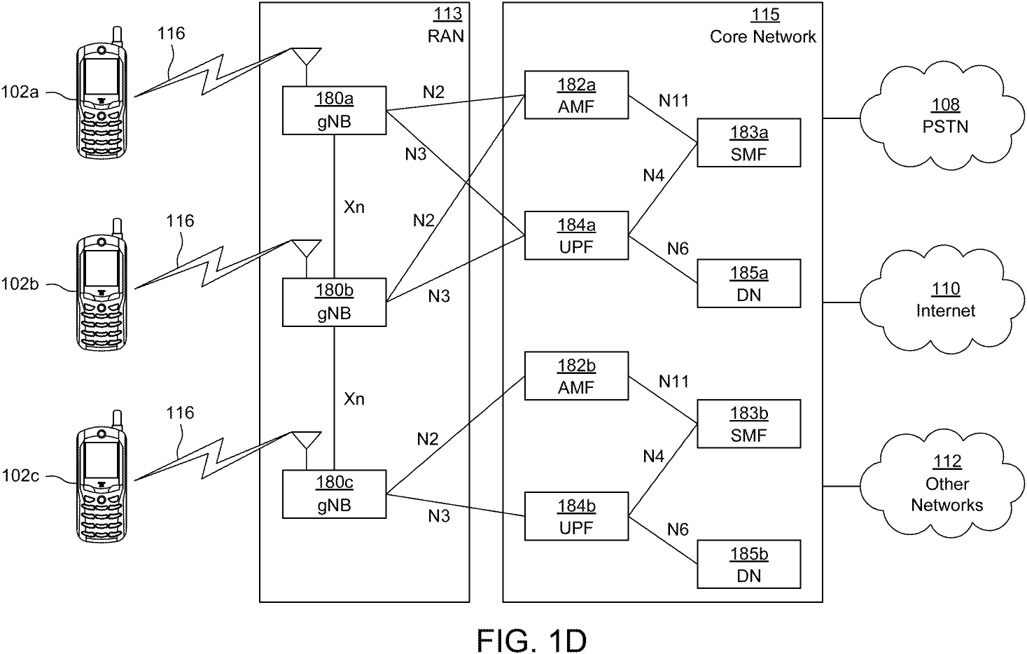

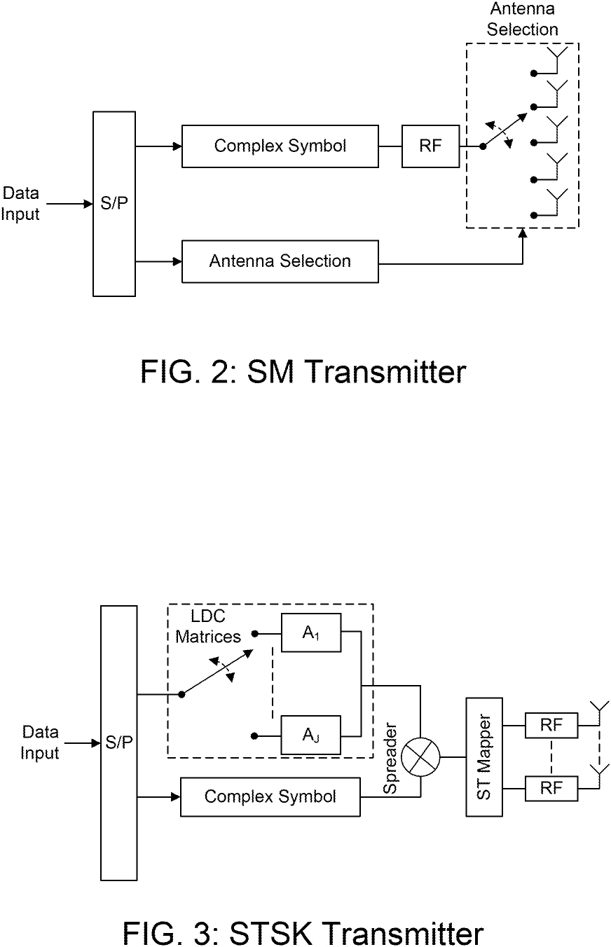

FIG. 2 is a block diagram of a SM transmitter. Referring to FIG. 2, SM is a modulation technique in which a single RF-chain based (Nₜ × Nᵣ)-antenna element (AE) may be used to activate only one AE out of Nₜ AEs, for example with the aid of both a transmit AE selection unit and a sufficiently fast switch for transmitting a single PSK/QAM symbol at the activated AE. This may allow the system to implicitly convey log2(Nₜ) bits of the activated AE index information in addition to log2(L) bits of the transmitted symbol information.

### Representative Space-Time Shift Keying (STSK) Transmitter

FIG. 3 is a block diagram of a STSK transmitter. Referring to FIG. 3, in STSK, a single space-time (ST) dispersion matrix is activated, for example to attain multiplexing and diversity gains relative to SM, which lacked any transmit diversity gain. To attain additional diversity gains, space-time dispersion matrices may typically be constructed prior to the commencement of transmission, for example to disperse a set of PSK/QAM symbols over both time and space for either improving the achievable capacity or enhancing the attainable diversity order. In STSK, linear dispersion code (LDC) based space-time dispersion matrices may be employed in the context of SM. For example, the data input may be divided into two streams as follows: (1) a first stream may be used to select one out of J LDC based dispersion matrices; and (2) a second stream may be fed into a symbol modulator, for example to generate a complex symbol (e.g., a QAM, PSK symbol). The complex symbol may then be spread over the space and time dimensions of the LDC matrix and may be mapped to different RF chains using of a space-time (ST) mapper. The STSK codeword obtained may be transmitted using the available transmit antennas.

### Representative Multi-Set STSK (MS-STSK) Transmitter

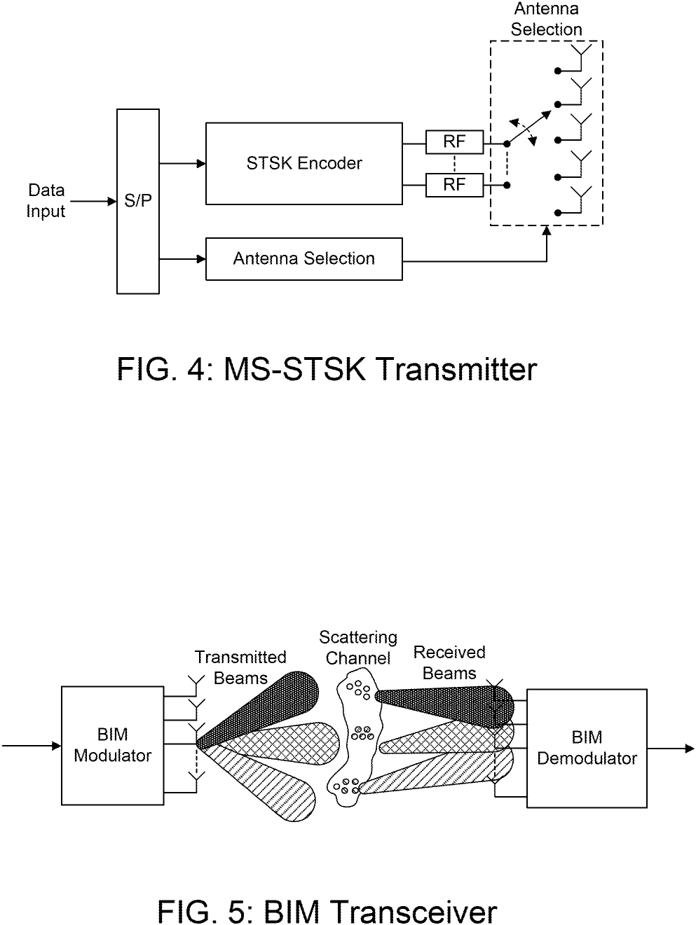

FIG. 4 is a block diagram of a MS-STSK transmitter. Referring to FIG. 4, a STSK enhancement may be implemented in which the merits of SM and STSK may be amalgamated into a single system, for example to achieve an increased throughput and/or enhanced BER performance compared to both techniques without any extra RF chain requirements. In MS-STSK, the input bit sequence may be partitioned into two parts. The first part may be utilized for generating the STSK codeword and the other part may be used to select a specific Antenna Combination (AC) of M AEs. The number of transmit RF-chains may be equal to that of the STSK spatial dimension M, and the number of transmit AEs Nₜ may be higher than M, for example to achieve a multiplexing gain in the activated antenna index domain, yielding Nₜ ≥ M. The transmitted information may include both the STSK codeword and the selected AC index.

### Representative Beam-Index Modulation (BIM) Transceiver

FIG. 5 is a block diagram of a BIM transceiver. Referring to FIG. 5, when a channel supports a plurality of beams, (e.g., N_{b} beams), a transmitter may use all or a subset of the beams to attain better performance and/or increased throughput depending on the number of RF chains. The choice of beams to use may be dependent on some quality measures, or in case of beam index modulation (BIM), the transmitter may select a specific beam for transmission depending upon the input bit-sequence. Each of the transmitted beams can be identified separately at the receiver side. Using a single RF chain, a BIM implementation may achieve an additional bit rate of log2(N_{b}) bits per channel relative to that of its counterpart dispensing with BIM.

The information components of the aforementioned schemes are summarized in Table 1 and their achievable gains are presented in Table 2 as follows.

TABLE 1

Schemes transmit information components

| | | | | |
|---|---|---|---|---|
| Scheme | Complex symbol | Antenna Index | Dispersion Matrix | Beam Index |
| SM | X | X | - | - |
| STSK | X | - | X | - |
| MS-STSK | X | X | X | - |
| BIM | X | - | - | X |

TABLE 2

Schemes achievable gains

| | | | |
|---|---|---|---|
| Scheme | Diversity | Multiplexing | Beamforming |
| SM | - | X | - |
| STSK | X | X | - |
| MS-STSK | X | X | - |
| BIM | - | X | X |

At high frequencies (e.g., in a range above 6 GHz), such as with millimeter waves (mmWaves), a characteristic of the wireless channel is its high path loss which may limit the number of propagation rays linking the transmitter and the receiver. In such a sparse wireless channel, where spatial degrees of freedom may be reduced, MIMO schemes, such as SM and/or STSK, may not or do not operate effectively as they may require a high-rank channel condition such that a unique channel impulse response can be associated with each transmit antenna. Due to the high path loss at high frequencies, antenna beamforming may play a role (e.g., an essential role) in providing robust/reliable communication links.

In certain representative embodiments, method, apparatus, systems, operations and procedures may be implemented for MIMO schemes/architectures/designs, for example to achieve multi-functional MIMO benefits (e.g., primarily flexibility) at high frequencies where the wireless channel is typically sparse. For example, a multi-functional MIMO technique may be implemented that can simultaneously achieve multiplexing, diversity and/or beamforming gains at high frequencies, where the wireless channel is typically sparse.

Representative embodiments are disclosed herein accumulatively (e.g., incrementally) over three implementation/architectures/schemes including: (1) beam-time-shift-keying (BTSK), multi-set BTSK (MS-BTSK) and multi-set polarized BTSK (MSP-BTSK). In these schemes, information is conveyed over multiple components, which provides greater flexibility with more degrees of freedom. Antenna beamforming may play a part (e.g., a pivotal role) in the transmission, for example to maintain robust and reliable links.

### Representative BTSK Transmitter

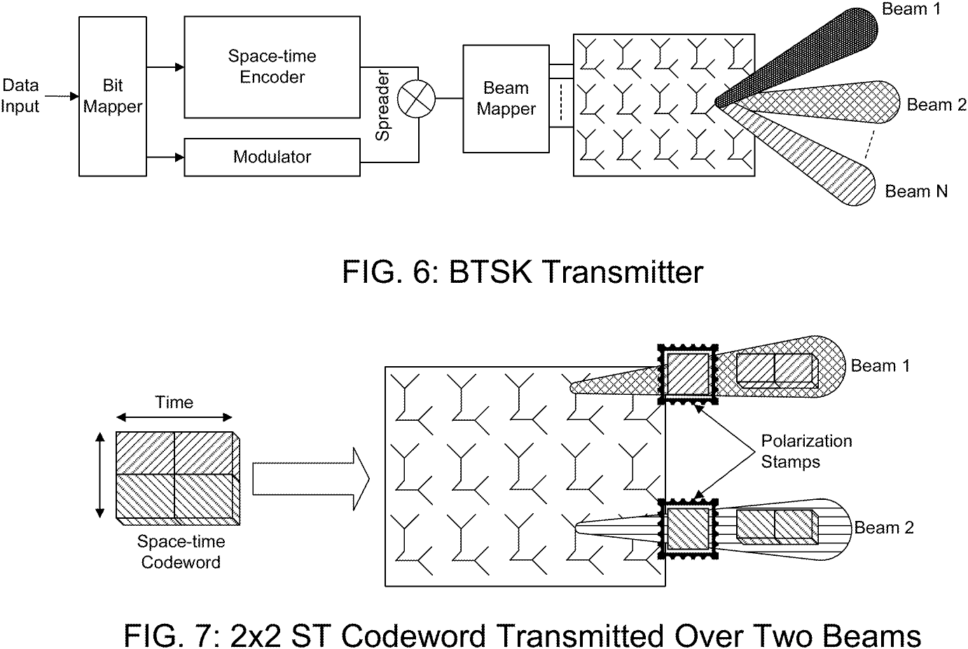

FIG. 6 is a block diagram of a BTSK transmitter. Referring to FIG. 6, information may be conveyed using a plurality of components (e.g., two components), for example space-time spreading matrices and complex symbols. Space-time codewords may be transmitted using different beams (e.g., rather than using transmit antennas as in other MIMO schemes such as STSK). The beams may be generated by implementing one or more large antenna arrays, which may produce/generate one or more distinct radiation beams.

The input bit stream may split into multiple streams (e.g., two streams): A first stream may be input to a symbol modulator, (e.g., QAM and/or PSK modulator, among others). A second stream may be used to select the ST spreading/dispersion matrix.

The complex symbol may then be dispersed over the ST matrix using a spreader. The dispersed ST codeword may be fed into (e.g., input to) a beam mapper, which may map the dispersed ST codeword onto a plurality of separate beams. The ST codeword may be transmitted over the separate beams.

Characteristics of BTSK: may include any of:
(1) the ST spreading matrix may be used to disperse a transmission signal over space and time (e.g., the ST matrix designs may range from a single (1×1)-element scalar to multiple large complex ST codes. A single ST matrix may indicate that no information is transmitted over the ST matrix component (e.g., reduced multiplexing) and a scalar may imply no ST dispersion (e.g., reduced reliability));
(2) beams may be defined by their angular characteristics and/or their polarization stamps (e.g., the angular characteristics may allow different beams to experience different fading channel and the polarization stamp may provide a mechanism/unique identifier to determine each respective beam);
(3) beams may vary as the channel changes, and may require/use constant/frequent updates with the receiver; and/or
(4) a polarization stamp may be established by manipulating a polarization state of the transmitted signal (e.g., this may be achieved by employing one or more arrays (e.g., large/massive arrays) of Multi-Polarized Antenna Elements (MP-AEs) that may produce a specific number of distinct beams and polarization states), among others.

The BTSK architecture/design/operation may attain diversity and multiplexing gains (e.g., a trade-off between the achievable diversity and multiplexing gains (dependent on the spreading matrix used)), and beamforming gain (e.g., attainable beamforming gain).

FIG. 7 is a block diagram of a representative beamforming operation for example with 2×2 ST codeword transmitted over multiple beams (e.g., two or more beams).

Referring to FIG. 7, a system/transmitter and/or receiver may employ 2×2 ST codewords, with multiple RF chains (e.g., two RF chains) and/or multiple beams (e.g., two beams) used to transmit/receive the ST codeword, for example in multiple slots (e.g., two time slots). The channel may be analyzed (e.g., characteristic of the channel may be determined) to check/determine whether the channel supports a plurality of beams (e.g., 2 or more beams). If (or on condition that) 2 or more beams are supported, the transceiver may determine or decide which beams (which number of beams (e.g., two beams)) to use for the ST codeword transmission. The beams (e.g., the two beams with a highest received signal strength (RSS) or another transmission and/or reception characteristic) may be selected/used. The input bit stream may be split into two parts with one part used to modulate a PSK/QAM symbol and the other part used to select one out of N LDC codes available.

### Representative Multi-Set BTSK (MS-BTSK) Transmitter

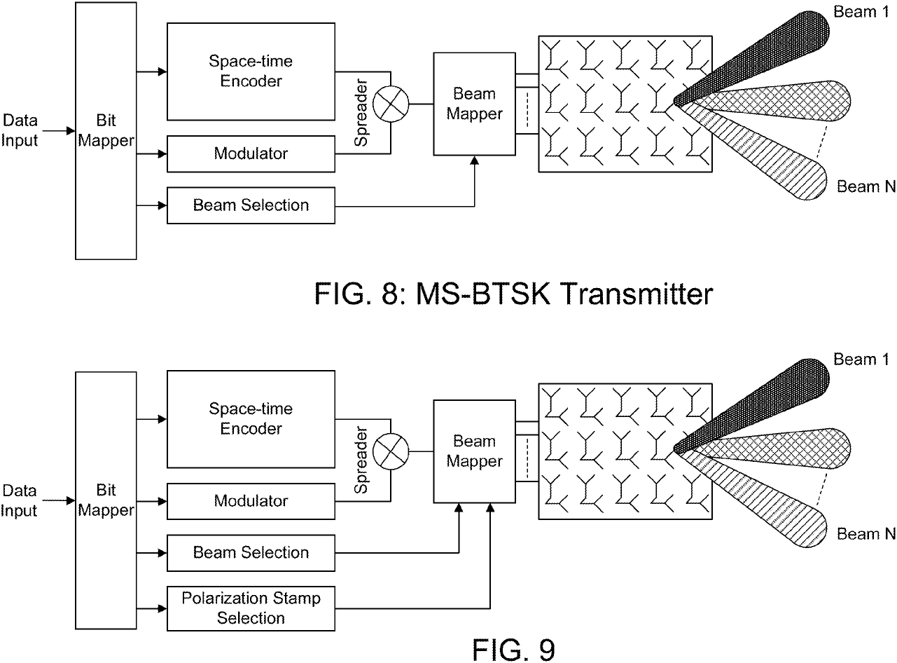

FIG. 8 is a block diagram of a representative MS-BTSK transmitter.

Referring to FIG. 8, BTSK may be extended to MS-BTSK in which the selected beams are used for transmission and there are more beams than required/needed by the dispersion matrices. For example, the achievable beams may be divided into multiple sets, where a set (e.g., each set) may include a single beam or a combination of beams. The active set of beams may be selected depending on the input bit sequence. The input bit stream in MS-BTSK may be split into multiple streams (e.g., three streams) including: (1) a first bit stream for complex symbol modulation; (2) a second bit stream for selecting a ST dispersion matrix; and/or (3) a third bit stream for the index of the active beam set. The number of RF chains used and/or needed may depend on the space-dimension of the ST codeword. For instance, a (2×2)-element may use or may require 2 RF chains. By utilizing the beam index, the MS-BTSK transmitter/architecture/design may allow further design flexibility in order to attain a flexible trade-off in the attainable diversity, multiplexing and/or beamforming gains.

In BTSK and MS-BTSK, polarization stamps may be used (e.g., may only be used) for: (1) separating beams over the polarization dimension; (2) improving the independency of different beams; and/or further enhancing the reliability of the transmission links.

### Representative Multi-Set Polarized BTSK (MSP-BTSK) Transmitter

FIG. 9 is a block diagram of a representative MSP-BTSK transmitter.

Referring to FIG. 9, MSP-BTSK may include another degree of freedom (e.g., a fourth degree of freedom) relative to MS-BTSK and may use polarization (e.g., polarization state/information/indicator, one or more polarization stamps and/or one or more polarization indexes). For example, the input bit stream to the MSP-BTSK transmitter may be divided into a plurality of streams (e.g., four streams) including, for example: (1) a first stream which may be fed/input into a symbol modulator; (2) a second stream which may be used for selecting a spreading matrix, for example of a plurality of spreading matrices; (3) a third stream which may be used for indicating an index of the beam (e.g., for selecting one or more beams via indices); and/or (4) a fourth stream which may be used to select a polarization stamp (e.g., for selecting one or more polarization stamps, for example, on a per beam basis).

The MSP-BTSK transmitter may spread (e.g., start off by spreading) a complex symbol over space and time using a spreading matrix and may select a set of beams (e.g., one or more beams). The MSP-BTSK transmitter may tune one or more beams with a given polarization state (e.g., generate one or more beams with a particular polarization state (e.g., horizontal polarization or vertical polarization, among many others) over which the spread symbol may be transmitted. The use of the polarization state/stamp may allow the system to achieve an improved multiplexing gain (e.g., by transmitting information over/using four components) and/or may provide an enhanced diversity gain (e.g., by dispersing information over different beams, different polarizations, space and/or time). The MSP-BTSK architecture/procedures/techniques are a generalized framework that has BTSK and MS-BTSK as special cases. Table 3 shows the information components of each technique.

TABLE 3

Information components of various BTSK-based configurations

| | | | | |
|---|---|---|---|---|
| Configuration | Symbol | ST Matrix | Beam Index | Polarization Stamp |
| BTSK | X | X | - | - |
| MS-BTSK | X | X | X | - |
| MSP-BTSK | X | X | X | X |

Although MSP-BTSK, BTSK and MS-BTSK are shown in detail, other special cases associated with MSP-BTSK are equally possible. For example, one of skill understands that the polarization may be used with BTSK, as Polarized BTSK (P-BTSK) to provide another degree of freedom and/or a polarization stamp to uniquely indicate each beam. As another example, the use of dispersion based on an ST-Matrix may be eliminated but the other aspects maintained. Thus, it is contemplated that any number of the information components (e.g., divided streams) may be used in any combination to generate a particular architecture.

It is also contemplated that a flexible architecture may be implemented by selecting which aspects (e.g., information components to enable based on receiver side information, services required, QoS requirements, channel estimates, channel characteristics, frequencies used, transmitter capabilities and/or latency requirements, among others).

### Beams in Representative BTSK-Based Schemes/Implementations

In BTSK systems (e.g., all BTSK-based systems), ST codewords may be transmitted over multiple beams that may be or are distinctive at the receiver, for example by segregating the propagation of signals over multiple beams. In certain examples, this may be in a similar manner to spatial separation of antennas in MIMOs that allows the transmission of independent signals over multiple antennas). For example, large antenna implementations (e.g., via one or more antenna arrays) may enable generation/obtaining of multiple beams (e.g., any number of beams) by relying on antenna beamforming techniques. Each beam may propagate differently and may experience diverse scatterers, which may be identified (e.g., identified separately) at a receiver. The beams may be separated (e.g., angularly separated) and may be detected at the receiver using their spatial characteristics including their Angle of Departure (AOD) and/or Angle of Arrival (AOA).

In certain representative embodiments including BTSK-based schemes, architecture, and/or procedures including some flexible architectures, polarization stamping may be implemented as a mechanism/operation for beam identification (e.g., as a unique beam indictor) and/or to provide beam separation/beam orthogonality. The polarization information/index may enable an increase in the number of beams for communication between or among one or more transmitters and one or more receivers. One, some or each beam and/or one, some or each set of beams may be assigned a specific polarization stamp.

For example, in BTSK-based schemes, polarization stamping may be implemented for any number of reasons including: (1) it may be used as a mechanism for beam separation/beam tracking, where a single polarization stamp may be applied to each beam (e.g., each active/selected beam). This may further separate the active beams over the polarization dimension on top of a conventional angular separation and/or (2) the polarization stamps may be used as information carriers, where polarization stamps may be selected based on the input data.

For example, a polarization stamp may be indicated/defined by a polarization state (e.g., a specific polarization state such as vertical, horizontal or circular, among others) that is distinct from other polarization stamps. Applying polarization stamps may be achieved by manipulating the polarization characteristics of MP-AEs, which may attain multiple polarization states. BTSK may be based on spatial/angular separation of the beams to attain a full gain. Adding a polarization stamp may reduce or may substantially eliminate a residual correlation (e.g., any residual correlation) between or among beams (e.g., with different polarization stamps).

Transmission beams change over time as scatterers change and may be updated (e.g., may require constant updating in coordination with the receiver side). Given a mobile environment, the beam directions and the number of available beams may vary with time (e.g., over a period of time). The transmitter and/or receiver may keep monitoring (e.g., may need to keep monitoring) a channel, for example to keep updating the beams used for transmission in lieu of or in addition to updating the transmission scheme depending on the number of available beams. The beams may be selected using RSS of the beams and/or ordering the beams according to their angle of arrival, for example.

In certain representative embodiments, for example in certain BTSK architectures/method and/or procedures, no information is transmitted over beam indices and/or over polarization stamps. Beam selection may be independent from bits modulation. In this case, the number of beams (e.g., only the required, for example minimum, number of beams) is activated to transmit the ST codeword, which may be selected for example based on the best RSS. For example, on condition that a space-time spreading matrix is used that requires/uses two beams and the channel supports four beams, the transmitter and/or receiver may determine/communicate which beams (e.g., which two beams) to use together with their polarization stamps. One possibility is to use the RSS to decide/determine which combination of beam and polarization stamp to use and to select the best two combinations of such beams and polarization stamps.

In certain representative embodiments, for example in certain MS-BTSK architectures, method and/or procedures, information may be transmitted over active beams’ indices. The receiver may be updated (e.g., may be constantly updated) with new beams or beam sets and their indices. Polarization stamps in BTSK and/or MS-BTSK may be used for beam separation (e.g., may be used only for beams separation over the polarization dimension). If the receiver cannot separate different polarization states, the polarization stamps may be excluded at the transmitter side.

In certain representative embodiments, for example in certain MSP-BTSK architectures, method and/or procedures, polarization stamps may be a part (e.g., an integral part) of the transmitted information. Similar to MS-BTSK, beams may be updated (e.g., constantly updated), for example with the transmitter and/or receiver. The attainable polarization states may be updated (e.g., constantly updated) with the transmitter and/or receiver, for example to enable/secure stable communications. For example, by such updates, indistinguishable polarizations stamps/shapes may be ignored in the modulation process.

In BTSK-based schemes/implementations, the polarization stamp may be advantageous (e.g., particularly advantageous) in Line-of-Sight (LOS) scenarios. For example, applying polarization stamps on beams may enable beam separations, when angular separation is not sufficient or possible in LOS scenarios.

### Representative MSP-BTSK Transmitter

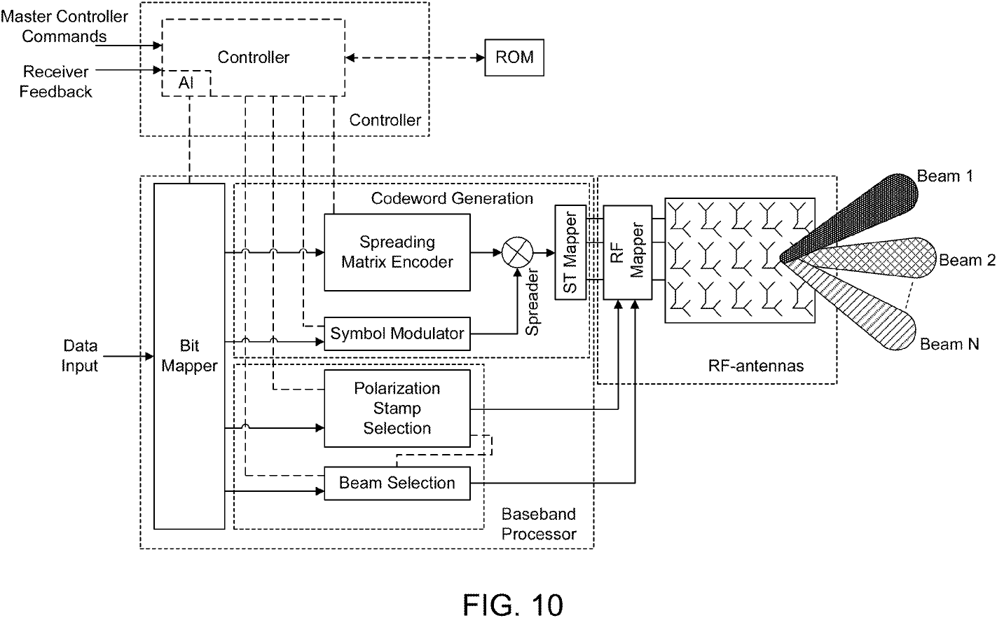

FIG. 10 is a diagram of a representative MSP-BTSK transmitter including a controller. Referring to FIG. 10, the MSP-BTSK transmitter may include a baseband processor, a controller/control unit and/or RF-antennas/RF-antenna unit. The baseband processor may perform baseband signal processing. The controller may communicate with the baseband processor control signaling and/or commands, among others based on configuration inputs and/or any feedback received from the receiver (via for example feedback and/or a monitored channel/feedback channel, among others). The antenna-RF unit may be a polarization- state-capable antenna array/matrix and may include M RF chains and a Nₜ transmit AEs. In certain representative embodiments, for example using MSP-BTSK, a plurality of inputs (e.g., two main inputs) to the transmitter may be implemented including a data input and a control input. The data input may be fed/input into the MSP-BTSK baseband processor and the control signaling (e.g., control data) may be fed/input into the controller (e.g., a control unit).

### Representative Baseband Processor

The baseband processor may be responsible/used for preparing the baseband signal and/or forwarding the baseband signal to the RF-antennas/RF-antenna units. The baseband processor may constitute and/or include a plurality of components (e.g., four main components) including a complex symbol modulator, a spreading matrix encoder, a polarization stamp selection unit/module/circuit and/or a beam selection unit/module/circuit. The complex symbol modulator may modulate input bits based on a specific constellation (e.g., QAM, or any other constellation type). The constellation type may be obtained from the controller. The spreading matrix encoder may include Nₛ spreading matrices. Based on the data input bits, the spreading matrix encoder may select and/or may output one or more spreading matrices (e.g., one out Nₛ spreading matrices). The active spreading matrix set may be obtained/acquired from the controller.

The polarization stamp selection unit may contain, provide for, and/or include the polarization stamps. The active polarization stamp set may be obtained/acquired from the controller.

The beam selection unit may enable selection of one or more of the beam candidates to provide/select one, some or all available beams.

The spreader and the ST mapper may be used for spreading the complex symbol over the ST spreading/dispersion matrix and for mapping the ST codeword obtained to the RF-Antenna unit. Both the polarization stamp selection unit and the beam selection unit may be used to control the RF-antenna unit. For example, the polarization stamp selection unit and the beam selection unit are used to activate one or more specific beams and a specific polarization stamp corresponding to each activated beam. In certain representative embodiments, the polarization stamp may provide a unique identifier of an active beam.

### Representative RF-Antenna Unit

The RF-Antenna unit may consist of and/or may include an RF mapper and/or one or more antenna arrays. The RF mapper may receive a ST codeword (e.g., a dispersed ST symbol) from the ST mapper and may map the ST codeword into a plurality of active beams selected by the beam selection unit. The RF mapper may apply the selected polarization stamps to the active beams in accordance with or as defined by the polarization stamp selection unit.

### Representative Control/Feedback Interfaces

In certain representative embodiments, the controller may interface (exclusively interface) with each of the other units/modules/circuits (e.g., the complex symbol modulator, the spreading matrix encoder, the polarization stamp selection unit/module/circuit and/or the beam selection unit/module/circuit) to control the MSP-BTSK transmitter. In other representative embodiments, interfaces (e.g., between one or more of the other units) may be implemented in lieu of or in addition to the controller interfaces to enable for example direct feedback from one unit to another unit. For example, it is contemplated that an interface may be implemented between the polarization stamp selection unit and the beam selection unit, for example to enable faster processing and/or lower latency of beam and polarization information and other direct interface are equally possible.

### Representative Procedures for MSP-BTSK Transmission

A transmission procedure (e.g., a flexible transmission) may include any of following:
(1) the data input to the baseband processor may be divided into up to four data streams with the aid of (e.g., using) a bit mapper converter, which may rely on a specific control signal from the controller (e.g., the controller may control the bit mapper to generate 1-4 streams which may be respectively input to any of: (i) the spreading matrix encoder, (ii) the symbol modulator; (iii) the polarization stamp selection unit and/or (iv) the beam selection unit);
(2) a first stream may be fed/input into a symbol modulator of the Codeword Generation unit to generate a single complex symbol;
(3) a second stream may be used (e.g., may next be used) by (e.g., fed/input to) the spreading matrix unit of the Codeword Generation unit to select one out of the available Nₛ spreading matrices;
(4) the complex symbol obtained from the first stream may be spread over the space and/or time dimensions of the selected spreading matrix using the spreader of the Codeword Generation unit;
(5) a space-time (ST) mapper of the Codeword Generation unit may forward the space-time code to the RF-Antenna unit to transmit one, some or each row of the ST codeword over a separate beam;
(6) a third stream may be used by (e.g., fed/input to) a beam selection unit to tune the antenna array to a specific beam by selecting one (or many) out of the available N_{B} beams. It is contemplated that the number of beams activated in each transmission may be equivalent to a space-dimension size of the ST spreading matrix. For example, a (2×2)-elements ST spreading matrix may use or may require activating 2 beams over 2 time slots;
(7) a fourth stream may be fed/input into a polarization selection unit to select/choose one (or a combination) out of Q polarization states and to adjust the polarization configurations of the antenna arrays, accordingly; (e.g., the polarization state selection unit may be performed, for example using the following techniques: (i) each of the selected beams may have a unique polarization state; (ii) a single polarization state may be applied to all of the beams for transmission; (iii) one or more subsets of transmitted beams may share a common polarization state; and/or
(8) the ST codeword may be transmitted over the selected beams and over and/or using a specific polarization state, among others.

It is contemplated that the bit mapper may map of the input data onto any number of steams (e.g., up to four streams) and that one of skill in the art understands that the controller may dynamically change the transmission scheme by modifying the configuration of these steams (e.g., disabling/enabling different streams and/or components in the baseband processor). For example, by disabling the fourth stream, the modulation technique/type may be changed from MSP-BTSK to MS-BTSK. As another example, the spreading matrix encoder may be disabled while maintaining the second stream to generate another modulation type (e.g., P-BTSK). The MSP-BTSK of FIG. 10 may provide a flexible architecture for carrying out a large number of modulation type such that a modulation type may be selected which can optimize the operating conditions of the transmitter and/or the receiver.

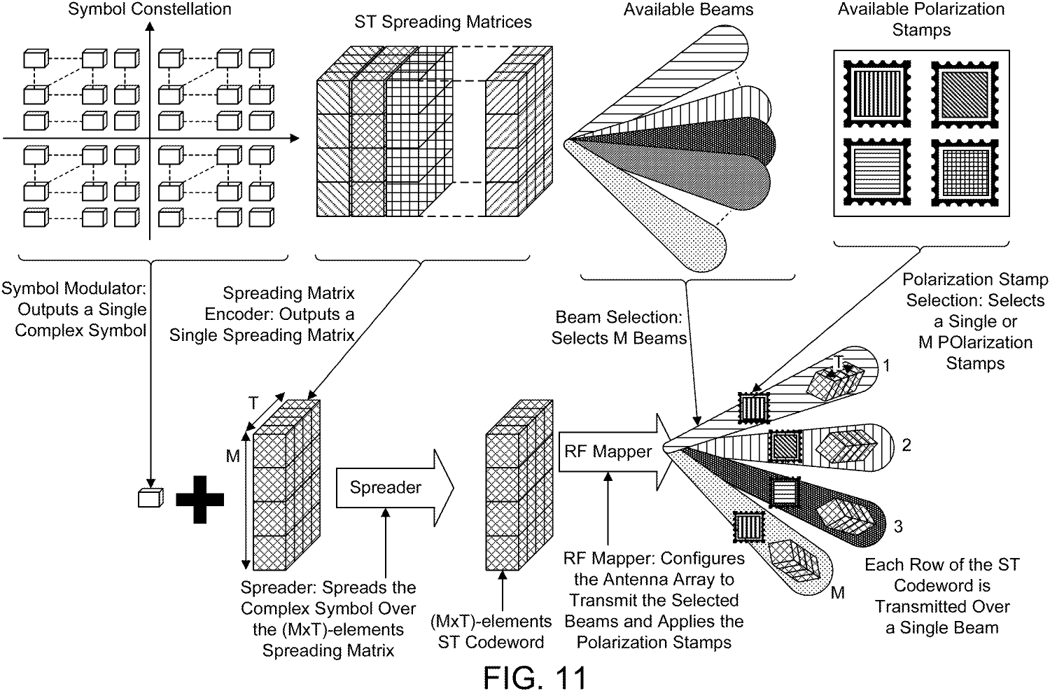

As an example, the MSP-BTSK modulation/transmission process may be illustrated with reference to FIGS. 10 and 11. The information components of the MSP-BTSK transmitter may include any of the following: (1) a symbol constellation (shown in FIG. 11) which may be obtained by the Symbol Modulator of FIG. 10; (2) ST Spreading matrices (shown in FIG. 11) which may be generated/stored/processed for example by the Spreading Matrix Encoder of FIG. 10 (e.g., the Spreading Matrix Encoder may hold the set of available spreading matrices); (3) Available Beams (shown in FIG. 11) may be selected by the Beam Selection component/unit of FIG. 10 (e.g., the Beam Selection unit may have the information about the available beams); (4) Available Polarization stamps (shown in FIG. 11) may be stored in the Polarization Stamp Selection unit of FIG. 10.

The input data stream may be divided into four streams and fed into the four modulation components. The Symbol Modulator may generate a single complex symbol from the available symbol constellation, e.g., a QAM/PSK constellation. The Spreading Matrix Encoder may select a single (MxT)-element spreading matrix out of the available set of spreading matrices. The Beam Selection unit may determine/select/choose a combination of M beams, and the Polarization Stamp Selection unit may select a single polarization stamp or a combination of the available polarization stamps. The complex symbol may be spread over the space and/or time dimensions of the spreading matrix with the aid of or using the Spreader to obtain an (MxT)-element ST codeword. The (MxT)-element ST codeword may be transmitted over the selected beams, where a row (e.g., each row) may be transmitted over a distinct beam. Hence, M beams are activated for transmitting the (MxT)-element ST codeword. If a single polarization stamp is selected, all beams (e.g., active beams) may share the same polarization stamp. When multiple polarization stamps are selected, a beam (e.g., each beam) may be assigned a different polarization stamp.

FIG. 11 is a diagram of a representative MSP-BTSK encoding process. Referring to FIG. 11, a complex symbol may be selected from a QAM/PSK constellation. A single spreading matrix may be selected to spread the complex symbol over the space and time domains using a spreader. The beam selection unit may determine/select/choose a single beam or a combination of beams and may set the polarization state for the single beam or combination of beams (e.g., (i) a single polarization state, for example a unique polarization state for each selected beam), (ii) a single polarization state for all of the selected beams or (iii) a plurality of polarization states with each polarization state associated with one or more selected beams).

The spreading matrix can be flexibly generated to be transmitted over: (1) one or multiple antennas, (2) one or multiple beams, and/or (3) one or multiple time slots, for example to attain a space-time transmit diversity gain, which may improve a reliability of the corresponding wireless link. The system may achieve an improved multiplexing gain, for example by conveying information over three independent streams, which may translate to log(LN_{D}N_{B)} bit per symbol per time slot. Different types of spreading matrices may be employed according to the system requirements/operation. For instance, orthogonal space-time codes (OSTBCs) may be used for achieving full diversity, while STSK spreading matrices may be used to attain diversity and multiplexing gains.

### Representative Transmitter Controller

The controller may control each of the components of the transmitter based on specific input from upper layers and any feedback from users. The operations of the controller may include any of:
(1) taking input from upper layers and processing any feedback information received from one or more receivers;
(2) selecting/determining/choosing a specific transmission configuration and providing/ circulating configuration information/configuration parameters to the components (e.g., modulation components);
(3) enabling adaptive transmission by:
   (i) configuring or preconfiguring, defining or predefining multiple configurations in advance (e.g., and stored in a memory unit) and known to the transmitter and receiver; and/or
   (ii) adjusting, by the controller, the baseband processor, for example to switch between these configurations based on feedback (e.g., a feedback signal) (for instance, in the case of having a good channel condition, the controller may switch to: (a) a full multiplexing configuration, (b) the full diversity configuration in faded channel conditions (e.g., severely faded channel conditions), and/or (c) a multifunctional configuration in which a multi-functional gain may be applied in mild channel conditions, for example to simultaneously achieve diversity and multiplexing gains;
   (iii) updating (e.g., adaptively updating) the transmitter configurations based on feedback signals (for example, the polarization states configurations may be updated (e.g., continuously updated) depending on or based on the channel state and users’ feedback (and the same applies to other components);
(4) enabling flexibility by activating and/or deactivating, by the controller, any of the transmitter components based on, for example specific feedback signals;
   (This flexibility may allow the MSP-BTSK system to adapt to changes in requirements/operations and to the variation in the channel. For instance: (i) the polarization stamp may be deactivated as an information carrier, and the modulation type/scheme changed/ downgraded to a MS-BTSK scheme and/or (ii) the beam index and the polarization stamps may be deactivated, and the modulation type/scheme changed/reduced to a BTSK scheme, among others.

This flexibility may allow the system to overcome fluctuations (e.g., severe fluctuations) in the channel and adaptively switch to from one service type/requirement (e.g., URLLC service, eMBB service or MTC service, among others) to another service type/requirements (e.g., URLLC service, eMBB service, or MTC service, among others).

FIG. 12 is a diagram illustrating a representative controller of an MSP-BTSK transmitter. Referring to FIG. 12, the controller may provide output orts for a plurality of interfaces (e.g., 5 interfaces) to connect to the baseband processor to execute MSP-BTSK transmission. The interfaces may include any of:

a first interface 1 that may be used to control the bit mapper or other input data processing unit such a serial-to-parallel conversion (e.g., that may map the input data to different parallel streams).

(For instance, the bit mapper may multiplex various stream sizes based on a determination and/or control signalling from the controller. For example, the bit mapper may multiplex 4 bits to stream 1 instead of multiplexing 6 bits in accordance with or per a determination/control signalling from the controller, for example as a result of a change in the channel state);

other interfaces 2, 3, 4 and 5 that may connect to each of the information units (e.g., the spreading matrix, the PSK/QAM modulator, the beam selection unit and/or the polarization selection unit), for example to adapt their constellations/datasets based on a determination by the controller.

### Representative MSP-BTSK Receiver

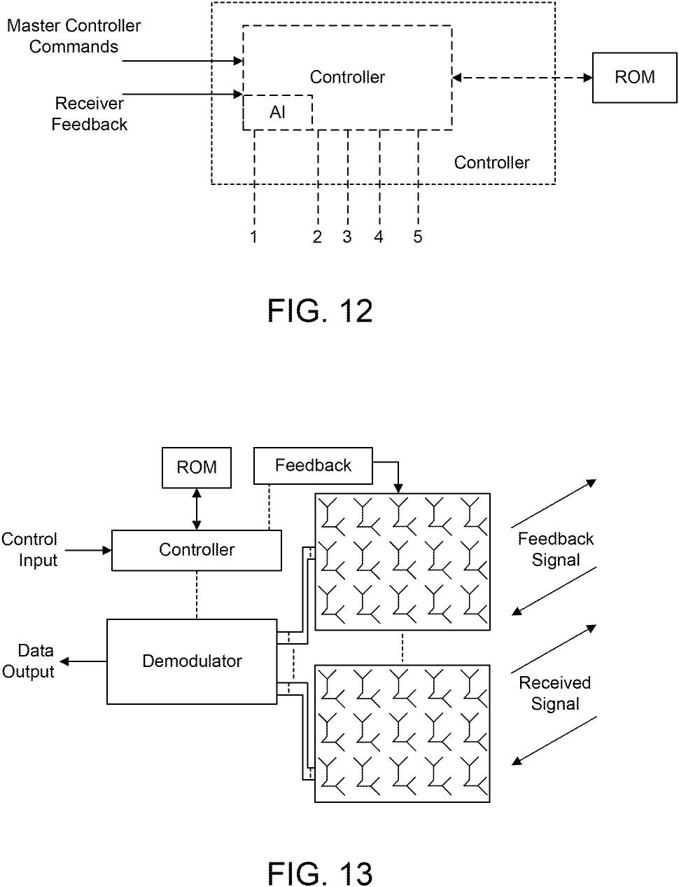

FIG. 13 is a diagram illustrating a representative MSP-BTSK receiver. Referring to FIG. 13, the MSP-BTSK receiver may be equipped/implemented with one or more antenna arrays with a total of Nᵣ receive AEs, an MSP-BTSK demodulator, a controller with access to memory (e.g., a ROM) and/or a feedback unit. The receiver operations may include any of the following:
(1) the receiver may receive the MSP-BTSK configuration signalling from the transmitter, which may contain or include information about and active configuration;
(2) the controller of the receiver may receive a specific configuration from the ROM, which may store possible transmission configuration options and may forward the specific configuration, configuration information and/or configuration parameters to the demodulator;
(3) the receiver may detect the polarization state with the aid of (e.g., using) multi-polarized antenna elements;
(4) the demodulator may demodulate the ST codeword, the beam indices and/or the polarization state of the received signal; and/or
(5) the receiver may send feedback information to the transmitter, and the feedback information may include any of: (i) channel state information (CSI); and (ii) information about the beams and/or polarization states, (e.g., the beams set and the distinctive polarization states may vary as the channel changes), among others.

Signalling from the transmitter may include instructions about the active alphabet (e.g., any of: (i) symbol modulation, (ii) ST codes, (iii) beams and/or (iv) polarization stamps, among others). The transmitter signalling may constitute the updated beam arrangements, which may vary upon the changes in the channel over time.

### Representative Layered MSP-BTSK (LMSP-BTSK) Architecture/Operations

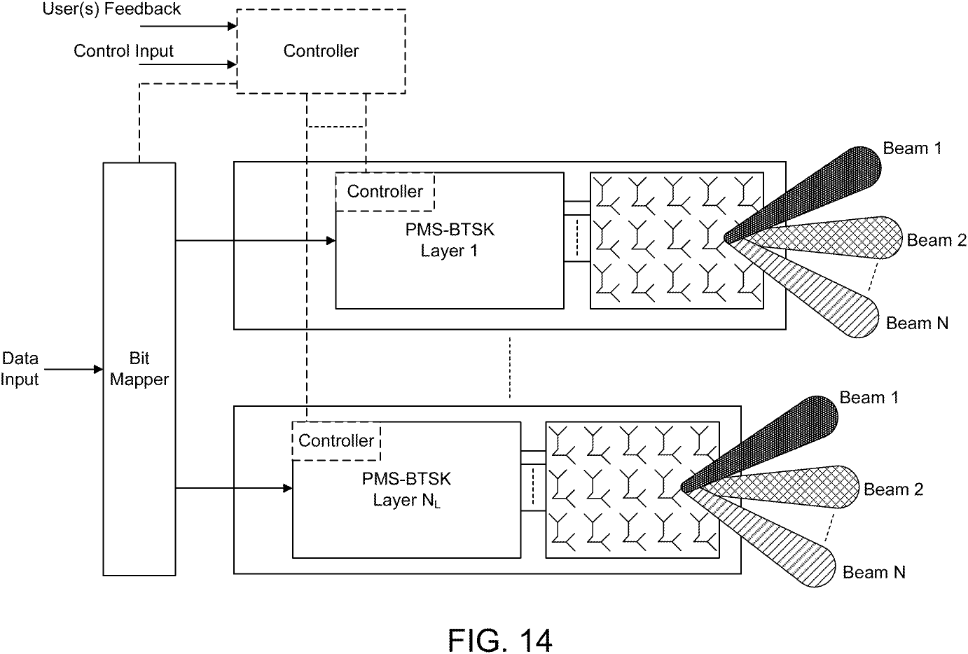

FIG. 14 is a diagram illustrating a representative LMSP-BTSK transmitter. Referring to FIG. 14, an MSP-BTSK transmitter may be viewed as a single layer MSP-BTSK transmitter, where a single baseband controller may represent and/or generate a single layer. Multiple layers may be implemented, which may be decoupled from the underlying hardware through virtualization of transmission layers. In FIG. 14, each of the MSP-BTSK layer may be independent from each other (e.g., any number of MSP-BTSK layers may be generated via suitable hardware such as one or multiple baseband processors/controllers), in a similar manner to spatial multiplexing and each set of the available RF chains and antenna elements may be assigned to a specific layer. In certain representative embodiments, the receiver architecture may remain unchanged.

It is contemplated that a single layer may use a single antenna array or a group of antenna arrays.

In certain representative embodiments, a central controller may be implemented that may be connected to controllers (distributed controllers distributed across all layers, as shown in FIG. 14. The distributed controllers may operate as disclosed herein for any controller. The central controller may have any of the following operations/functions: (1) communicate control signals, decisions and/or feedback information with distributed controllers; (2) constructs MSP-BTSK layers (e.g., the central controller may decide/determine a number of layers, based on the system requirements, and may divide the available RF chains and antenna arrays among the determined layers); (3) provide adaptive layering (e.g., the central controller may use the feedback (e.g., feedback signals/information) to adaptively configure the layering structure. The central controller may change the number of layers and/or the transmission configuration of one or more layers or each layer based on the feedback, for example from users. For example, a single-layered system may assign the whole RF-antenna block to a single layer, which may be divided, for example into N layers (e.g., four layers), where one or more layers or each layer transmits an independent signal which may be different from other layers.

In certain representative embodiments, space-time spreading matrices may be spread over beams and each part of the space-time codeword may be transmitted over a separate beam.

In certain representative embodiments, a polarization stamp/modulation (e.g., using a polarization state) may be implemented in each transmitted beam. The polarization stamps may be used for beam characterization and the beams may be defined using their spatial characteristics and/or their polarization stamp.

In certain representative embodiments, time varying beams may be implemented and information may be conveyed over the active transmission beams indices. Due to the time-varying nature of wireless channels, beams may be continuously updated at both the transmitter and receiver.

In certain representative embodiments, a flexible multifunctional design may be implemented which enables dynamic enablement and disablement (e.g., the switching on and switching off) of different components: The representative transmitter architecture/scheme may include any of multiple components (e.g., four transmission components) (for example complex symbols, ST spreading matrix, beams, and/or polarization stamps, among others). Based on a specific feedback information and/or control signaling, the transmitter may switch ON and switch OFF any of these components.

In certain representative embodiments, the flexible design may allow an adaptive layers structuring (e.g., the layering structure of, for example the MSP-BTSK transmitter can be adaptively constructed based on system requirements and/or feedback information.

In certain representative embodiments, the adaptive layering may be implemented according to changes in the system/environment (e.g., a BTSK-based system which is formed of multiple RF chains may be adaptively divided into multiple layers). The number of layers may vary according to the changing system requirements.

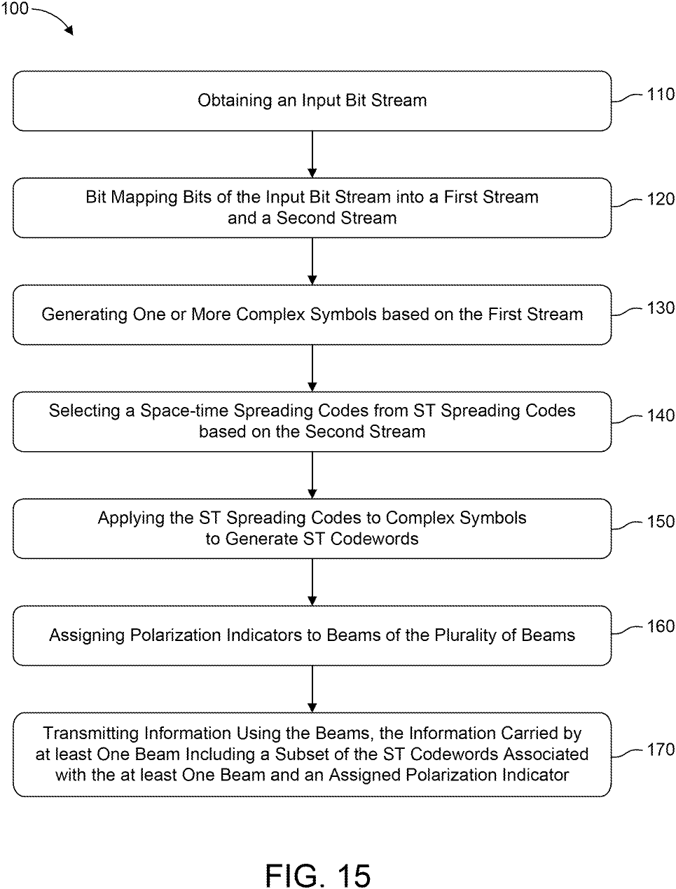

FIG. 15 is an example of a method 100, implemented by a transceiver, for transmitting via a plurality of beams. The method 100 may comprise the following steps. At step 110, an input bit stream may be obtained. At step 120, a bit mapper of the transceiver may bitmap one or more bits of the input bit stream into at least a first stream and a second stream. At step 130, a symbol modulator may generate one or more complex symbols based on the first stream. At step 140, a spreading matrix/codes encoder may select a space-time (ST) spreading matrix/codes from a plurality of ST spreading matrices/codes based on the second stream. At step 150, the ST spreading codes may be applied to the one or more complex symbols to generate (e.g., set of) one or more ST codewords. Particularly, the one or more complex symbols may be spread by using the ST spreading codes to generate the one or more ST codewords. At step 160, one or more polarization indicators may be assigned to one or more beams of the plurality of beams, each polarization indicator indicating a polarization state of the one or more beams. At step 170, information may be transmitted using the plurality of beams, the information carried by at least one beam of the plurality of beams including a subset of the one or more ST codewords associated with the at least one beam and an assigned polarization indicator.

Prior to assigning the one or more polarization indicators to the one or more beans of the plurality of beams, the bit mapper of the transceiver maybit map one or more bits of the input bit stream into a third stream; and the one or more polarization indicators may be selected based on the third stream for the plurality of beams. Prior to assigning the one or more polarization indicators to the one or more beans of the plurality of beams, the bit mapper of the transceiver maybit map one or more bits of the input bit stream into another stream; and a selection of one or more active beam may be based on another stream. The selection of the one or more polarization indicators may be based on a bit sequence of the third stream. Each of the one or more polarization indicators may comprises a beam identifier of a beam. Each beam identifier may uniquely identify a beam of the plurality of beams. The one or more polarization indicators may be updated based on a feedback signal. The one or more polarization indicators may be updated based on the one or more beams configuration of the plurality of beams. The one or more polarization indicators may be updated based on antenna configuration. The one or more updated polarization indicators may be transmitted to a receiver device so it may perform the demodulation of the transmitted information. The one or more updated polarization indicators may be sent in-band if updated frequently or semi-statically if updated less frequently (e.g., 5 -10 time slots). The one or more polarization indicators may be updated when the beam configuration or antenna configuration changes. The method 100 may further comprise a step of,

on condition that each of the plurality of beams is to be assigned a unique polarization indicator, determining whether the information to be transmitted on a first beam of the plurality of beams is to be unique relative to a second beam of the plurality of beams or redundant relative to the second beam of the plurality of beams.

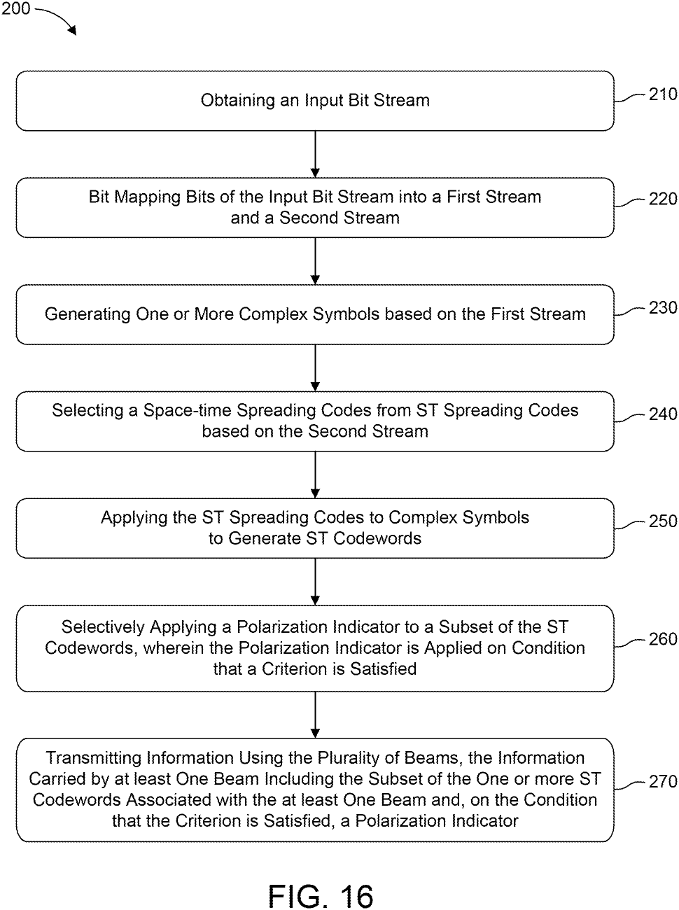

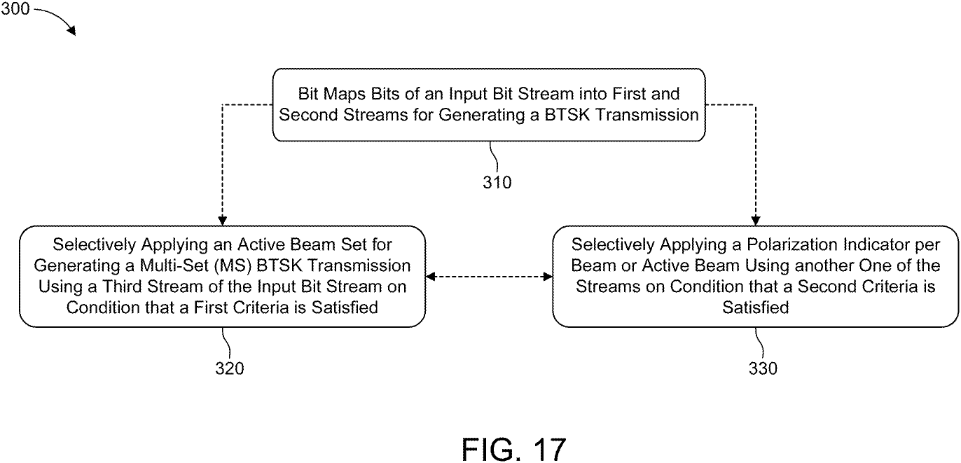

FIG. 16 is another example of a method 200, implemented by a transceiver, for transmitting via a plurality of beams. The method 200 may comprise the following steps. At step 210, an input bit stream may be obtained. At step 220, a bit mapper of the transceiver may bitmap one or more bits of the input bit stream into at least a first stream and a second stream. At step 230, a symbol modulator may generate one or more complex symbols based on the first stream. At step 240, a spreading matrix/codes encoder may select a space-time (ST) spreading matrix/codes from a plurality of ST spreading matrices/codes based on the second stream. At step 250, the ST spreading codes may be applied to the one or more complex symbols to generate (e.g., set of) one or more ST codewords. Particularly, the one or more complex symbols may be spread by using the ST spreading codes to generate the one or more ST codewords. At step 260, the transceiver may selectively apply a polarization indicator to a subset of the ST codewords, wherein the polarization indicator is applied on condition that a criterion is satisfied. At step 270, information may be transmitted using the plurality of beams, the information carried by at least one beam of the plurality of beams including the subset of the one or more ST codewords associated with the at least one beam and, on the condition that the criterion is satisfied, a polarization indicator. The criterion may be any of a channel condition, a request from another device; a user input; a new configuration from a network device; and/or a service requirement for a service associated with data being transmitted.

According both methods 100, 200 described above, bit mapping of the bits of the input stream may include at least a fourth stream used to determine indexes associated with one or more active beam sets, each active beam set corresponding to one or more beams of the plurality of beams. The methods 100, 200 may further comprising: determining one or more indexes based on a bit sequence of the fourth stream; selecting the one or more active beam sets based on the determined one or more indexes; and; mapping the one or more dispersed ST codewords to the one or more active beam sets in accordance with the determined indexes.

The bit mapping of the bits of the input stream includes at least a third stream used to select one or more polarization indicators, each of the polarization indicators indicating a polarization state of one or more beams of the plurality of beams. Both methods 100, 200 may further comprise the steps of: selecting a polarization indicator per beam for the plurality of beams that are used for the transmitting of the one or more dispersed ST codewords, the selecting of the polarization indicators being based on a bit sequence of the third stream, and generating each respective beam of the plurality of beams with the polarization state associated with the polarization indicator selected for the respective beam. Both methods 100, 200 may further comprise the step of determining a number of beams to be used for transmission of the one or more dispersed ST codewords based on a combination of (1) a number of different angular characteristics or a number of different beam directions which can be resolved by a reception device and (2) a number of different polarization states available for the plurality of beams. Both methods 100, 200 may further comprise a step of selecting a subset of the plurality of beams, as an active beam set, on condition that more beams are available than required by the selected ST spreading codes associated with the one or more dispersed ST codewords.

The transmitting of the information may include transmitting: (1) a first portion of the mapped one or more dispersed ST codewords using a first polarization state over a first beam and (2) a second portion of the mapped one or more dispersed ST codewords using a second polarization state over a second beam. The transmitting of the information may include transmitting: (1) a first portion of the mapped one or more dispersed ST codewords using a first polarization state over a first beam of a first active set of beams and a second portion of the mapped one or more dispersed ST codewords using the first polarization state over a second beam of the first active set of beams. The transmitting of the information may include transmitting: (1) a first portion of the mapped one or more dispersed ST codewords over a first beam of a first layer and a second portion of the mapped one or more dispersed ST codewords over a second beam of a second layer.

FIG. 17 is another example of a method 300, implemented by a device, for transmitting via a plurality of beams. The method 300 may comprise the following steps configured by a controller of the first device as a mode of operation. The mode of operation may comprise a step of bit mapping 310 bits of an input bit stream into first and second streams for generating a BTSK transmission. Additionally, for generating a Multi-Set (MS) BTSK transmission, the mode of operation may further comprise a step of selectively applying 320 an active beam set using a third stream of the input bit stream on condition that a first criteria is satisfied. Additionally, the mode of operation may further comprise a step of selectively applying a polarization indicator per beam or active beam using another one of the streams on condition that a second criteria is satisfied.

The first criteria and the second criteria may be based on any of: (1) feedback from a second device; (2) further user input; (3) a new configuration from a network device; and/or (4) a service requirement for a service associated with data being transmitted.

Another example of a method, implemented by a first device of transmitting over a plurality of beams may comprise the following steps: determining, based on feedback from a second device and/or user input, a type of BTSK for a transmission to the second device; configuring, by a controller of the first device, one of a first mode of operation, a second mode of operation, a third mode of operation or a fourth mode of operation, wherein: in the first mode of operation, the first device bit maps bits of an input bit stream into first and second streams for generating a BTSK transmission; in the second mode of operation, the first device bit maps bits of the input bit stream into first, second and third streams and selects an active beam set for generating a Multi-Set (MS) BTSK transmission; in the third mode of operation, the first device bit maps bits of the input bit stream into first, second, third and fourth streams, selects an active beam set using one of the streams and assigns a polarization indicator per beam using another one of the streams for generating a Multi-Set Polarized (MSP) BTSK transmission; or in a fourth mode of operation, the first device bit maps bits of the input bit stream into first, second and third streams and assigns a polarization indicator per beam for generating a Polarized BTSK (P-BTSK) transmission.

Each of the following references: (1) R. Y. Mesleh, H. Haas, S. Sinanovic, C. W. Ahn and S. Yun, “Spatial Modulation,” IEEE Transactions on Vehicular Technology, vol. 57, pp. 2228-2241, 7 2008; (2) S. Sugiura, S. Chen and L. Hanzo, “Space-Time Shift Keying: A Unified MIMO Architecture,” in IEEE Global Telecommunications Conference, 2010; (3) I. A. Hemadeh, M. El-Hajjar, S. Won and L. Hanzo, “Multi-Set Space-Time Shift-Keying With Reduced Detection Complexity,” IEEE Access, vol. 4, pp. 4234-4246, 2016; and (4) Y. Ding, V. Fusco, A. Shitvov, Y. Xiao and H. Li, “Beam Index Modulation Wireless Communication With Analog Beamforming,” IEEE Transactions on Vehicular Technology, vol. 67, pp. 6340-6354, 2018 are incorporated by reference herein.

Systems and methods for processing data according to representative embodiments may be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within a vehicle and/or another mobile device remotely. In the later a case, data may be transferred via wireline or wirelessly between the vehicles or other mobile device.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU’s operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods. It should be understood that the representative embodiments are not limited to the above-mentioned platforms or CPUs and that other platforms and CPUs may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶ 6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Throughout the disclosure, one of skill understands that certain representative embodiments may be used in the alternative or in combination with other representative embodiments.

In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method, implemented by a transceiver, of transmission via a plurality of beams, the method comprising:
obtaining an input bit stream;
stream;bit mapping one or more bits of the input bit stream into at least a first stream and a second
generating one or more complex symbols based on the first stream;
selecting a space-time (ST) spreading codes from a plurality of ST spreading codes based on the second stream;
applying the ST spreading codes to the one or more complex symbols to generate one or more ST codewords;
assigning a first polarization indicator to a first subset of the plurality of beams and a second polarization indicator to a second subset of the plurality of beams, the first polarization indicator indicating a first polarization state of the first subset of the plurality of beams and the second polarization indicator indicating a second polarization state of the second subset of the plurality of beams; and
transmitting the one or more ST codewords using the plurality of beams, wherein each beam of the first and second subset subsets of the plurality of beams respectively includes the first and the second assigned polarization indicators.

2. The method of claim 1, further comprising;
prior to the assigning, bit mapping one or more bits of the input bit stream into a third stream; and
selecting the first and the second polarization indicators based on the third stream for the plurality of beams.

3. The method of claim 1, further comprising;
prior to the assigning, bit mapping bits of the input bit into another stream; and
selecting one or more active beams, as the plurality of beams, based on the another stream.

4. The method of claim 2, wherein the selecting of the first and the second polarization indicators is based on a bit sequence of the third stream.

5. The method of claim 1, wherein the first polarization indictor comprises a beam identifier and the second polarization indicator comprises another beam identifier.

6. (canceled)

7. The method of claim 1, further comprising:
updating the first and the second polarization indicators based on a feedback signal.

8. The method of claim 1, further comprising:
updating the first and the second polarization indicators respectively based on the first and second subsets of beams configuration of the plurality of beams.

9. The method of claim 1, further comprising:
updating the first and the second polarization indicators based on antenna configuration.

10. A method, implemented by a transceiver, of transmission via a plurality of beams, the method comprising:
obtaining an input bit stream;
bit mapping one or more bits of the input bit stream into at least a first stream and a second stream:
generating one or more complex symbols using the first stream;
selecting a space-time (ST) spreading codes from a plurality of ST spreading codes;
applying the ST spreading codes to the one or more complex symbols to generate one or more ST codewords;
selectively applying a polarization indicator to a subset of the ST codewords, wherein the polarization indicator is applied on condition that a criterion is satisfied; and
transmitting the one or more ST codewords using the plurality of beams including the subset of the one or more ST codewords associated with at least one beam of the plurality of beams, and on the condition that the criterion is satisfied, including the applied polorization indicator.

11. The method of claim 10, wherein the bit mapping of the bits of the input stream includes at least a third stream used to determine indexes associated with one or more active beam sets, each active beam set corresponding to one or more beams of the plurality of beams, the method further comprising:
determining one or more indexes based on a bit sequence of the third stream;
selecting the one or more active beam sets based on the determined one or more indexes; and;
mapping the one or more ST codewords to the one or more active beam sets in accordance with the determined indexes.

12-20. (canceled)

21. The method of claim 7, wherein the feedback signal comprises information indicating a channel state.

22. A transceiver, comprising circuitry including a transmitter, a receiver, a processor and memory, and configured to transmit via a plurality of beams, the transceiver being configured for:
obtaining an input bit stream;
bit mapping one or more bits of the input bit stream into at least a first stream and a second stream;
generating one or more complex symbols based on the first stream;
selecting a space-time (ST) spreading codes from a plurality of ST spreading codes based on the second stream;
applying the ST spreading codes to the one or more complex symbols to generate one or more ST codewords;
assigning a first polarization indicator to a first subset of the plurality of beams and a second polarization indicator to a second subset of the plurality of beams, the first polarization indicator indicating a first polarization state of the first subset of the plurality of beams and the second polarization indicator indicating a second polarization state of the second subset of the plurality of beams; and
transmitting the one or more ST codewords using the plurality of beams, wherein each beam of the first and second subsets of the plurality of beams respectively include the first and the second assigned polarization indicators.

23. The transceiver of claim 22, further configured for:
prior to the assigning, bit mapping one or more bits of the input bit stream into a third stream; and
selecting the first and the second polarization indicators based on the third stream for the plurality of beams.

24. The transceiver of claim 22, further configured for:
prior to the assigning, bit mapping bits of the input bit into another stream; and
selecting one or more active beams, as the plurality of beams, based on the another stream.

25. The transceiver of claim 23, wherein selecting the first and the second polarization indicators is based on a bit sequence of the third stream.

26. The transceiver of claim 22, wherein the first polarization indicator comprises a beam identifier and the second polarization indicator comprises another beam identifier.

27. The transceiver of claim 22, further configured for:
updating the first and the second polarization indicators based on a feedback signal.

28. The transceiver of claim 27, wherein the feedback signal comprises information indicating a channel state.

29. The transceiver of claim 22, further configured for:
updating the first and the second polarization indicators respectively based on the first and second subset of beams configuration of the plurality of beams.

30. The transceiver of the claim 22, further configured for:
updating the first and the second polarization indicators based on an antenna configuration.
